(19) United States
(12) Patent Application Publication
(10) Pub. No.: US 2010/0118426 A1
(43) Pub. Date: May 13, 2010

(54) WRITE CLOCK CONTROL SYSTEM FOR MEDIA PATTERN WRITE SYNCHRONIZATION

(76) Inventors: Barmeshwar Vikramaditya, Eden Prairie, MN (US); Bruce Douglas Buch, Westborough, MA (US); Mehmet Fatih Erden, Pittsburgh, PA (US); Mathew P. Vea, Shrewsbury, MA (US)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(21) Appl. No.: 12/267,168

(22) Filed: Nov. 7, 2008

(51) Int. Cl. G11B 5/09; G11B 21/02

(52) U.S. Cl. 360/51; 360/75; G9B/5.033

(57) ABSTRACT

A write clock control system comprises a clock controller that determines a phase offset based on a phase difference between a write clock signal and a media pattern corresponding to a given timing synchronization field being read, and a phase interpolator that produces an updated write clock signal by updating the phase of the write clock signal in accordance with control signals that are based on the phase offset signal.

### CROSS-REFERENCE TO RELATED APPLICATIONS

The present application is related to the following commonly-owned, copending U.S. Patent Applications, the content of each of which are incorporated herein by reference:

U.S. patent application Ser. No. ______, which was filed on Nov. 7, 2008, by Barmeshwar Vikramaditya et al. for a REDUCED READ/WRITE TRANSITION OVERHEAD FOR STORAGE MEDIA (File No. 108047-116); U.S. patent application Ser. No. ______, which was filed on Nov. 7, 2008, by Bruce Douglas Buch. for a WRITE PRECOMPENSATION SYSTEM (File No. 108047-118); U.S. patent application Ser. No. ______, which was filed on Nov. 7, 2008, by Bruce Douglas Buch et al. for a MEASUREMENT OF ROUND TRIP LATENCY IN WRITE AND READ PATHS (File No. 108047-120); U.S. patent application Ser. No. ______, which was filed on Nov. 7, 2008, by Bruce Douglas Buch et al. for ELIMINATING SECTOR SYNCHRONIZATION FIELDS FOR BIT PATTERNED MEDIA (File No. 108047-122); and U.S. patent application Ser. No. ______, which was filed on Nov. 7, 2008, by Bruce Douglas Buch et al. for INTERSPERSED PHASE-LOCKED LOOP FIELDS FOR DATA STORAGE MEDIA SYNCHRONIZATION (File No. 108047-123).

### BACKGROUND OF THE INVENTION

The invention relates in general to data processing systems that utilize bit patterned media and, in particular, to write clock control systems for such data processing systems.

Bit pattern media (“BPM”) consists of patterns of magnetic regions, or dots, within non-magnetic material. Write operations to BPM record data bits as one of two stable magnetization polarities in respective patterns of discrete dots in the writable portions of the media. This is in contrast to write operations to continuous magnetic media, in which transitions between magnetically opposite polarized regions may be recorded essentially anywhere on the writable portions of the media. With continuous media, the write clock has a fixed frequency that corresponds to a zone in which the data are being written. The write clock can thus be provided by a frequency synthesizer 202 (FIG. 2). Preambles, or training patterns, are written as part of the write operations, to depict the start of a sector being written and the start of the data within the sector. The training patterns also provide timing information for read clock synchronization, since the training patterns are written at the same time as the data, using the same write clock.

To read a given sector, the system locates the associated training pattern and synchronizes a variable frequency read clock to the phase and frequency of the pattern read from the disk. Subsequently, as the data in a sector are read, detected deviations from ideal clock synchronization, i.e., timing errors, are used to fine-tune the variable frequency read clock to maintain this synchronization. The synchronizing of the read clock to the data recorded in a sector is required, to overcome differences in disk speed, fly height and so forth, between the read and write operations.

At the start of a sector, the read clock is brought into frequency and phase synchronization with the recorded training pattern by a read channel digital phase lock loop in a timing “acquisition” mode. After the read clock is synchronized to the training pattern, the read clock is closely synchronized to the data, since the entire sector was written at the same time, using the same fixed-frequency write clock. Thereafter, when reading data, the read channel digital phase lock loop, in a “tracking” mode, uses timing errors detected from reading data to correct any residual error left from acquisition mode and maintain read clock synchronism with the data in the sector. The synchronization operations start again for a next sector, with the read channel phase lock loop staring again in acquisition mode to determine timing errors associated with the read clock using the training pattern that was recorded in the sector when the sector was written.

A conventional read channel digital phase lock loop is illustrated in FIG. 1. As shown in the drawing, a read signal is sampled by an analog to digital converter (“ADC”) 102 that is clocked by the updated read clock, which is fed back on line 101. The digital samples are provided to a data detector 104 that, operating in a known manner, detects data bits. In tracking mode, the data bit decisions and the read signal samples from the lo ADC are fed to a timing error detector 106 that operates in a known manner to detect timing errors using the data decisions and corresponding transitions in the read signal. Since the training pattern read during acquisition mode is known, the timing error detector utilizes the known pattern to detect timing errors rather than the data detector output signal.

The timing error detector 106 provides a timing error signal to the digital loop filter 108, which operates in a known manner to produce a frequency correction that controls a variable frequency generator 110. The generator, which is often also referred to as a digital voltage controlled oscillator, produces the updated read clock. The frequency generator is controlled by timing errors associated with the training pattern and data read from a sector, and the conventional phase lock loop endeavors to drive the read clock to the phase and frequency of the training pattern and subsequent data. The loop delay results in a lag between the detection of a timing error and the corresponding correction applied to the frequency generator.

The variable frequency generator 110 is shown in more detail in FIG. 2. The generator includes a frequency synthesizer 202 that generates a fixed, or constant, frequency that corresponds to the media zone of interest. As noted above, the fixed frequency was provided as the write clock when the data were written. The frequency correction information provided by the digital loop filter 108 is provided as an integrand to an adder 204 that combines the frequency correction information with the output of a phase register 206. The adder and the phase register operate together as a frequency integrator, and produce control signals for a phase interpolator 208. The phase interpolator applies a phase shift to the nominal frequency signal provided to it by the frequency synthesizer, to produce the updated read clock. Continual addition of an increasing or decreasing sequence of phase at each cycle results in an interpolator output which is frequency shifted from its input.

The training pattern utilized for read clock synchronization in the conventional system must be sufficiently long to derive the frequency information to drive the read clock into frequency and phase synchronism with the signal read from the media, taking into account the loop delay and the adverse effects of signal noise on the timing measurements.

For efficient utilization of BPM capacity, the write clock should be synchronous with the pattern of dots under the write head. Using the same digital phase lock loop that works well for synchronizing the read clock utilized with continuous media is not appropriate for control of a write clock used for BPM write operations, however, for a number of reasons. Firstly, the tracking mode of the digital phase lock loop used for reading is inapplicable, since during write operations there are no data being read from which to detect timing error. Consequently, although a training pattern can be read prior to a write operation to support an acquisition mode, no mechanism exists to correct residual error remaining after reading the training pattern. This in turn requires a very long training pattern to allow time for the phase lock loop to drive the clock to the precise level of phase and frequency synchronization needed to commence writing without concurrent timing error correction.

Secondly, the lack of a tracking mode obviates the ability to correct for disturbances that may create transient timing errors while writing. However, in contrast to continuous media operations, the write clock for BPM operations must be able to respond to disturbances, such as vibrations and so forth, during a write operation by making immediate adjustments to the write clock phase and frequency. Otherwise, the write transitions for a large span of bits may not be synchronized to dot positions, and single dots may then experience conflicting magnetization forces from the writer, resulting in bits of indeterminate states being written, and thus, multiple errors being recorded in the dots. Mitigating such scenarios requires highly redundant error correcting codes that reduce the available storage capacity. Similarly, the length of the training patterns utilized for clock synchronization also adversely affects the available storage capacity.

### SUMMARY OF THE INVENTION

A write clock control system comprises a write clock controller that determines a phase offset based on a phase difference between a write clock signal and a media pattern in a given timing synchronization field being read, and a phase interpolator that produces an updated write clock signal by updating the phase of the write clock signal in accordance with control signals that are based on the phase offset.

A method of controlling a write clock comprising the steps of determining a phase difference of a write clock relative to a media pattern in a given timing synchronization field by demodulating a signal that is read from the given timing synchronization field and sampled at the rate of the write clock; determining a phase offset based on the phase difference associated with the given timing synchronization field; and updating the phase of the write clock based on the phase offset.

A write clock control system comprises a write clock controller that produces a phase offset based on a phase difference between a write clock signal and a single frequency signal being read from a media pattern that corresponds to a given timing synchronization field, and a phase interpolator that produces an updated write clock signal based on the phase offset.

### BRIEF DESCRIPTION OF THE DRAWINGS

The invention description below refers to the accompanying drawings, of which:

FIG. 1 is a functional block diagram of a conventional read channel digital phase lock loop;

FIG. 2 is a functional block diagram of a variable frequency generator utilized in the read channel digital phase lock loop of FIG. 1;

FIG. 3 is a block diagram of a write clock control system;

FIG. 4 is a functional block diagram of a write clock controller utilized in the write clock control system of FIG. 3;

FIG. 5 is a functional block diagram of another write clock control system;

FIG. 6 is an illustration of a bit patterned media disk;

FIG. 7 is a graph of phase offset and frequency offset versus time;

FIG. 8 illustrates the format of the bit patterned media in more detail; and

FIG. 9 is a diagram that illustrates phase and frequency acquisition during a seek operation.

### DETAILED DESCRIPTION OF AN ILLUSTRATIVE EMBODIMENT

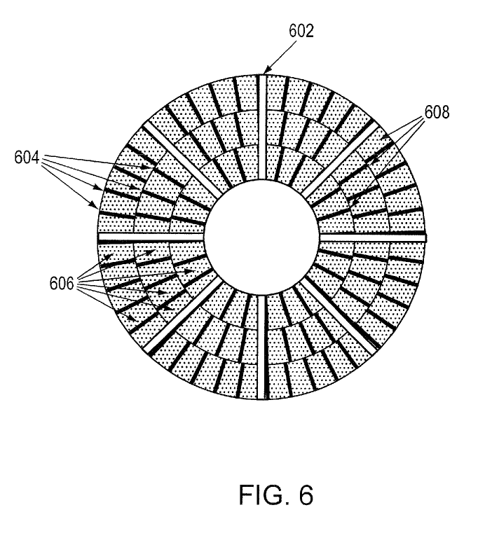

Before discussing the write clock control system, we describe the format of bit patterned media (“BPM”) used in the example. Referring to FIG. 6, a BPM disk 600 includes pre-recorded servo synch fields 602 that are radially coherent as a read head moves across the media and timing synchronization fields 604 that are interspersed in the writable portions 606 of disk. The timing synchronization fields are referred to hereinafter also as “PLL fields.” In the example, the PLL fields are radially coherent within zones 608 of the disk.

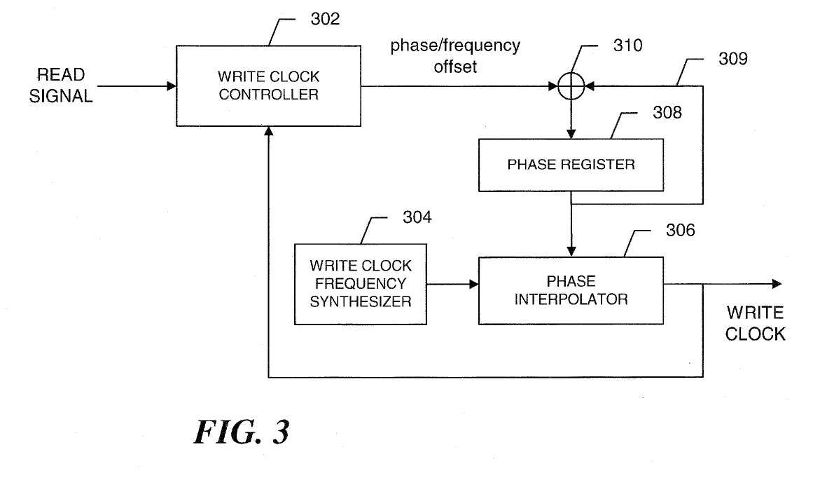

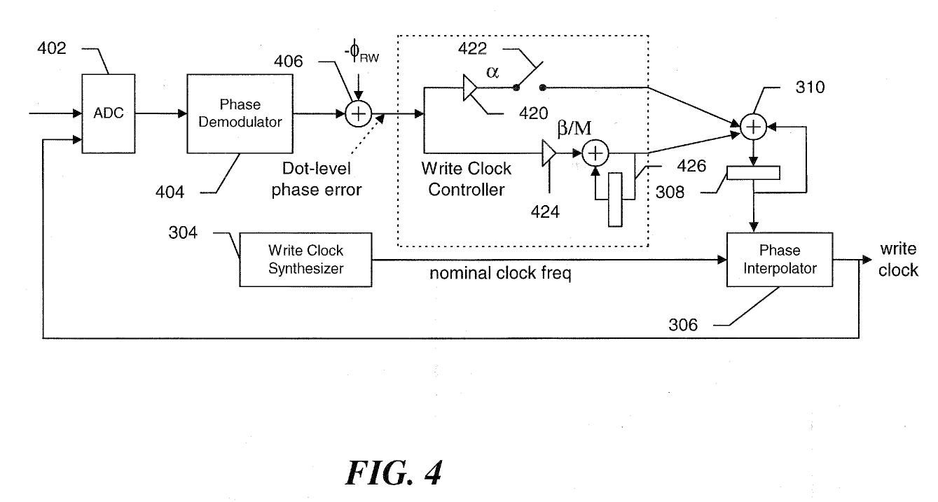

Referring now also to FIG. 3, a write clock control system 300 for use with BPM is shown. A write head, or writer, is blind to what is recorded on the disk, and thus, the write clock control system utilizes the read signal for write clock control. The signal read from a given PLL field 604 is provided to a write clock controller 302. The write clock controller, which is discussed in more detail below with reference to FIG. 4, determines directly from the read signal a phase offset of the write clock relative to the media, that is, relative to the pattern of dots in which the PLL field was written, and provides corresponding phase information in the form of an integrand through an adder 310 to a phase register 308. The phase information is used in one or a small number of clock cycles to update the phase of the write clock.

The write clock control system further determines a frequency offset based on the phase offsets associated with the given PLL field 604 and previously read PLL fields. The system provides the frequency offset information to the adder 310 along with the phase offset information. The output value produced by the phase register 308 is fed back on line 309 to the adder 310, which adds the output value to the phase offset value. The adder and phase register operate together as a frequency integrator, and the result is provided as a control signal to a phase interpolator 306. The phase interpolator is also provided with a write clock having a nominal fixed frequency that corresponds to the zone 608 in which the given PLL field is recorded, i.e., the zone in which the write operation writes the data. The nominal frequency write clock is produced in a known manner by a frequency synthesizer 304. The phase interpolator operates in accordance with the control signals to essentially instantaneously update the phase of the nominal frequency write clock, and through continuously-applied phase increments or decrements produces a write clock that is in both frequency and phase synchronism with the media.

Referring now also to FIG. 4, the write clock control system is described in more detail. The system includes an analog to digital converter (“ADC”) 402 that samples a read signal that, in the example, corresponds to information read from the given PLL field 604. The ADC is clocked by the write clock. The ADC samples the analog read signal at the write clock rate and, in a known manner, produces corresponding digital samples. The samples are provided to a phase demodulator 404, which determines the phase of the write clock relative to the media, that is, a phase difference between the write clock and a known reference signal that is pre-recorded in the pattern of dots that correspond to the PLL field.

The phase demodulator 404 provides the phase difference information to an adder 406, which adds a read-to-write phase offset that is associated primarily with the distance between the reader and the writer. The sum is a dot-level phase error.

The sum is provided to a gain element 420, which applies a proportional gain a to the phase difference, to calculate the phase offset signal that provides dot level phase correction. The phase offset is applied through a closed switch 422 to a single clock cycle, and the switch 422 otherwise remains open. The proportional term calculates a phase update based on the most recent phase error.

The sum is also provided to a gain element 424, which translates the dot-level phase error to a phase error associated with the interval between PLL fields and applies an integral gain β to calculate a frequency offset signal. The integral term calculates a frequency update that is based on the phase differences associated with the given PLL field and previously read PLL fields, through loop 426. In the example, the interval between PLL fields consists of M dots, and thus, the processor 424 divides the integral gain term by M. The integral term calculates a frequency update based on a weighted sum of the past phase differences

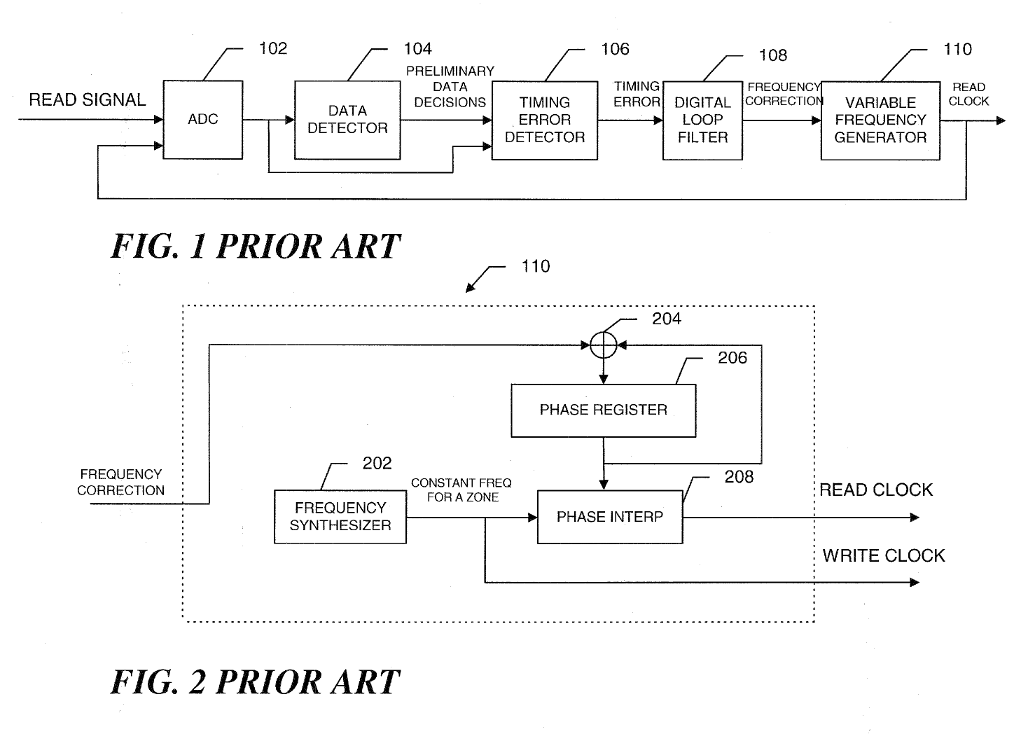

The write clock controller 302 provides the phase offset and frequency offset information to the frequency integrator, that is, the adder 310 and the phase register 308, which control the phase interpolator that updates the write clock. The updates to the write clock are thus made in an open loop fashion, that is, without the loop delay associated with a conventional read channel digital phase lock loop (FIG. 1), since the phase of the write clock relative to the media is determined directly from the read signal.

The phase correction is performed as a step that is provided to a single clock cycle or, as appropriate, a small number of clock cycles, through the switch 422. Frequency updates are made by applying a correction over the span of cycles to which the frequency update applies, for example, the cycles between PLL fields 604. The write clock phase may be updated as soon as the update is available from the write clock controller 302. Alternatively, the write clock may be updated when the writer (not shown) is over the next PLL field 604, while the data write operation is suspended. Between PLL fields, the write clock is free running. Accordingly, the PLL fields may be spaced so as to maintain write clock synchronization in the presence of disturbances.

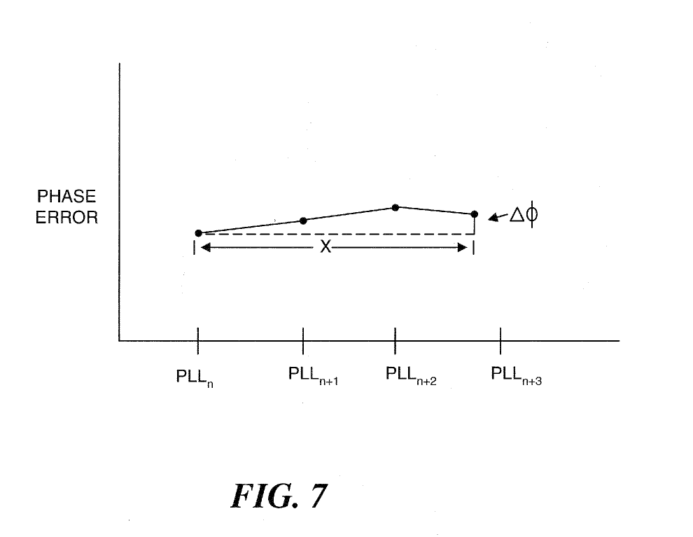

Referring also to FIG. 7, a graph illustrates the phase error associated with an PLL field being read, namely PLL field n+3, and three previously read PLL fields n, n+1 and n+2. The frequency offset is determined over the four PLL fields essentially as the slope of a line through the phase offsets, i.e., Δφ/x, while the phase offsets are determined for respective PLL fields. The frequency offset determined in this manner, that is, based on samples that are separated by the many clock cycles between PLL fields, provides a more accurate error estimation than is determined by a conventional read channel digital phase lock loop operating on a corresponding number of bit time samples in a contiguous training pattern, since frequency estimation error decreases with a greater sampling interval.

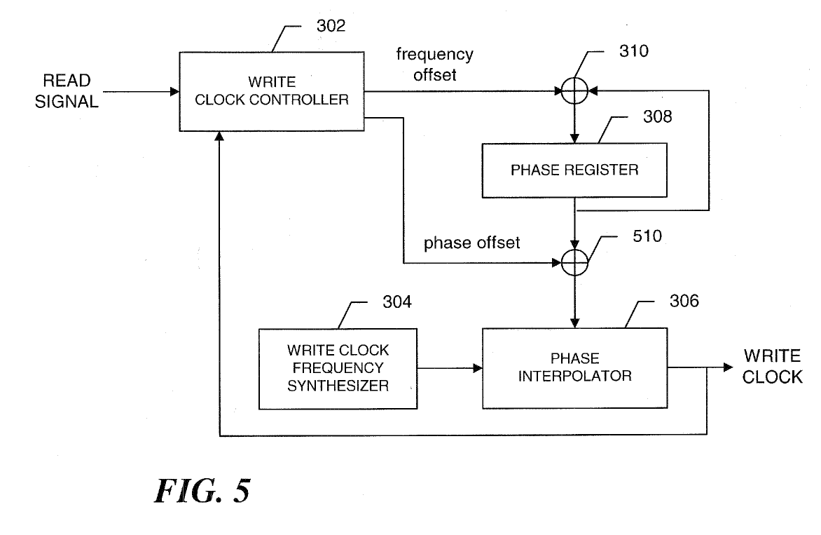

The write clock control system may be external to the channel. Accordingly, providing an integrand at the write clock rate may not be possible, and the clock controller 302 may instead provide the integrand at a clock rate that is one Nth of the write clock frequency. The phase adjustment would thus be divided by N and applied as steps over N cycles. Alternatively, as illustrated in FIG. 5, the clock controller 302 may supply a separate phase offset signal as a step through an adder 510 during one, a small number, or all N of the write clock cycles within an N cycle period.

In the embodiment discussed herein, the timing signal recorded in the PLL fields 604 is a single frequency burst of a predetermined number of dots periods per cycle. Accordingly, the relative phase of the write clock, that is, the phase of the single frequency PLL field relative to the write clock is readily demodulated using known techniques, such as discrete Fourier transform.

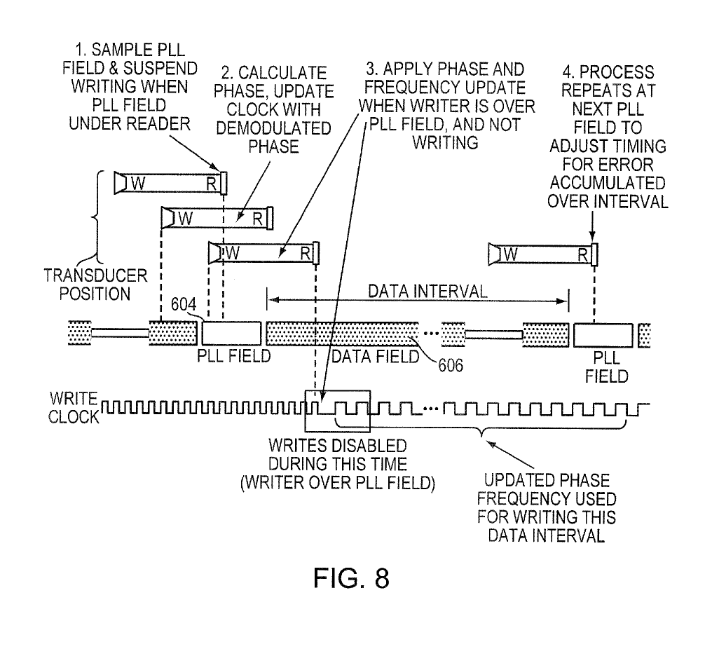

Referring also to FIG. 8, the format of the BPM is illustrated in more detail. As discussed, the timing synchronization signals are recorded in the PLL fields 604. With the use of the write clock control system, the PLL fields may be a small number of signal cycles long, for example, less than 10 signal cycles. As discussed in more detail below, the PLL fields need only be of sufficient length to demodulate the phase of the signal read from the PLL fields relative to the sample clock, i.e., the write clock, with its phase and frequency held constant. A single cycle of the read signal would be sufficient except for the adverse effects of both signal noise and analog to digital quantization on timing measurement. Based on several signal cycles, the system produces a single phase difference value. This is in contrast to conventional timing synchronization signals, such as preamble training patterns, in which the training patterns consist of the dozens of cycles that are required for phase and frequency synchronization of a read clock to a recorded signal, and the systems produce a correspondingly large number of phase difference values.

The PLL fields 604 are interspersed in the writable data fields 606 at the intervals that are required to maintain write clock synchronism. The PLL fields are radially coherent within zones 608 (FIG. 6). Further, the PLL fields are pre-recorded, read-only fields.

The timing synchronization signals are pre-recorded in the media dots of the PLL fields 604, and down track coherence with successive PLL fields within the same zone 608 are enforced by the dot patterns. Accordingly, successively read PLL fields within the same zone may be used together to determine write clock frequency synchronization, which is based on phase differences over the multiple samples that are used to update the clock. Here, the respective PLL fields constitute the multiple samples, since each PLL field is used to determine a single phase difference value that is used to update the write clock. Thus, the frequency updates are determined from the phases demodulated from successively read PLL fields. This allows each PLL field to be as short as is appropriate for phase demodulation, with the pattern length required for frequency synchronization spread over multiple PLL fields.

In contrast, the conventional read channel phase lock loop uses bit timed samples of the read signal and, after the associated loop delay, updates the sample clock, i.e., the read clock. The updated read clock is used to sample the read signal and, after the associated loop delay, the read clock is updated in accordance with timing errors associated with these samples, and so forth. The training pattern utilized by the conventional read channel phase lock loop must thus be sufficiently long to allow the loop, which relies on closed loop operation with its associated loop delay, to converge on a frequency that nullifies phase error.

Using the write controller 302 to estimate frequency error based on successive PLL fields, that is, samples that are separated by the many clock cycles between PLL fields, provides a more accurate error estimate than is determined by a conventional read channel digital phase lock loop operating on a corresponding number of bit time samples in a single contiguous training pattern, since frequency estimation error decreases with a greater sampling interval. Thus, the interspersing of the shorter PLL fields provides more accurate frequency measurement than the longer preambles used with conventional read channel phase lock loops. This is true even if the larger number of the short PLL fields consumes as much media storage capacity as the fewer, but longer, training patterns.

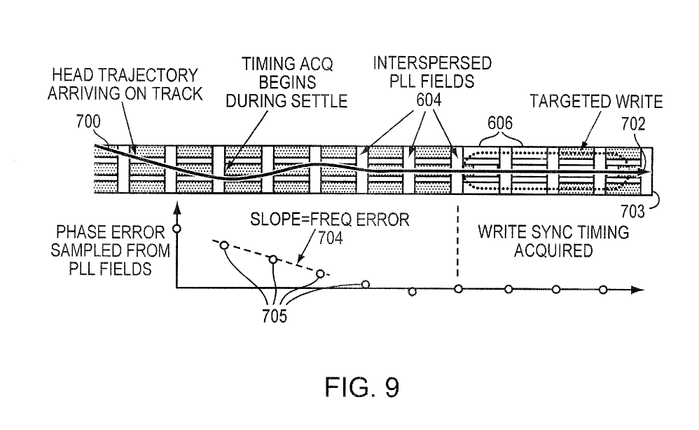

Referring also to FIG. 9, line 700 shows the trajectory of a head (not shown) arriving on a track 702 during a seek operation. The radial coherence of the PLL fields 604 permits phase and frequency acquisition to begin even before the track position is fully determined. Thus, the reader reads a signal from a first PLL field and the signal is used to determine a phase difference 705 between the write clock, with its frequency and phase held constant, and the media dot pattern. The system then updates the write clock based on the phase difference, as discussed above. When the reader is over a next PLL field, which is a known number of dots away, the reader reads the PLL field and updates the write clock in the same manner.

As discussed, the frequency error is the slope of a line 704 drawn through the phase differences 705, or errors, determined in previously read radially coherent PLL fields within the same zone. The write clock frequency is updated through continuously-applied phase adjustments, which are updated based on the phase differences associated with successively read PLL fields. Thus, the system synchronizes the phase and frequency of the write clock with the media generally within the time it takes for the head to settle into alignment during a seek operation.

This is in contrast to conventional continuous media systems, in which the training patterns are written as part of the write operations. The newly written training patterns do not have down track coherence with previously written training patterns, and thus, both phase and frequency synchronization must occur within a single, and necessarily longer, training pattern.

The write clock control system described with respect to FIGS. 3-5 provides immediate adjustments that allow the phase and frequency of the write clock to remain synchronized when disturbances such as vibrations induce changes in the frequency of the dot stream under the writer. Conventional digital phase lock loop systems used to synchronize read clocks do not have the ability to update the frequency and/or phase of the clock signal immediately and instead such updates are delayed by the associated loop delay. Accordingly, adopting a conventional read channel digital phase lock loop to operate with the write clock is not adequate for control of a write clock for use with BPM.

As also discussed, adopting a conventional read channel digital phase lock loop to control the write clock requires the use of a single contiguous training pattern to achieve phase and frequency synchronization of the write clock with BPM dots that follow the pattern, since the tracking mode of the digital phase lock loop used for reading is inapplicable. Using the digital phase lock loop in this manner fails to exploit the phase coherence of BPM, and results in less efficient timing acquisition as well as less accurate frequency error estimations.

The write clock control system may operate whenever the PLL fields are read, regardless of whether or not a write operation is in progress. This provides the write control system with phase differences over the previously read PLL fields to provide frequency offset information, and ensures that the write clock remains in synchronism with the media.

The foregoing description has been directed to specific embodiments. It will be apparent, however, that other variations and modifications may be made to the described embodiments, with the attainment of some or all of their advantages. For example, the processor, demodulator and controller depicted separately may be combined or a processor, demodulator or controller depicted individually may consist of several processors, demodulators or controllers. Further, the respective PLL fields may be pre-recorded with other known signals and need not be radially coherent. Accordingly this description is to be taken only by way of example and not to otherwise limit the scope of the invention. Therefore, it is the object of the appended claims to cover all such variations and modifications as come within the true spirit and scope of the invention.

What is claimed is:

1. A write clock control system comprising
a clock controller for determining a phase offset based on a phase difference between a write clock signal and a media pattern in a given timing synchronization field being read; and
a phase interpolator for producing an updated write clock signal by updating the phase of the write clock signal in accordance with control signals that are based on the phase offset.

2. The control system of claim 1 wherein
the clock controller further determines a frequency offset based on the phase offsets associated with the given timing synchronization field and previously read timing synchronization fields, and
the phase interpolator further updates the write clock signal by updating the frequency of the write clock signal in accordance with control signals that are based on the frequency offset.

3. The control system of claim 2 further including a phase integrator that integrates an integrand that consists of a combination of the phase and frequency offset signals and a feedback signal that is the output of the phase integrator, the phase integrator producing the control signals.

4. The control system of claim 2 wherein the phase offset updates the phase of the write clock as a step applied to a small number of write clock cycles.

5. The control system of claim 4 wherein the small number is one.

6. The control system of claim 3 wherein the phase offset is included in the integrand for a small number of integration cycles.

7. The control system of claim 6 wherein the small number of integration cycles is one cycle.

8. The control system of claim 2 further
including a phase integrator that integrates an integrand signal that consists of the frequency offset and a feedback signal that is the output of the phase integrator, and
the control signal consists of a combination of the output signal of the phase integrator and the phase offset.

9. The control system of claim 1 wherein the clock controller includes a phase demodulator that determines the phase difference of the write clock relative to a single frequency signal read from the given timing synchronization field.

10. The control system of claim 9 wherein the phase demodulator receives a plurality of samples of the signal read from the given timing synchronization field, with the samples taken at the rate of the write clock, and determines a single phase offset.

11. The system of claim 10 wherein the timing synchronization fields are interspersed in writable portions of the tracks.

12. The system of claim 11 wherein the timing synchronization fields occur at intervals to maintain synchronization of the write clock to the zone media pattern.

13. Method of controlling a write clock comprising the steps of
determining a phase difference of a write clock relative to a media pattern in a given timing synchronization field by demodulating a signal that is read from the given timing synchronization field and sampled at the rate of the write clock;
determining a phase offset based on the phase difference associated with the given timing synchronization field;
determining a frequency offset based on the phase difference associated with the given timing synchronization field and phase differences associated with previously read timing synchronization fields; and
updating the phase and frequency of the write clock based on the phase and frequency offsets.

14. The method of claim 13 wherein the step of updating includes
updating the phase as a step, and
updating the frequency by application of a continually-applied phase offset to incrementally increase or decrease the phase.

15. The method of claim 13 wherein the step is applied to one write clock cycle.

16. The method of claim 13 wherein the step is applied over a predetermined number of cycles of the write clock.

17. The method of claim 13 wherein the updating step includes updating the phase and frequency of the write clock when an associated write head is over the given timing synchronization field.

18. The method of claim 13 wherein the timing synchronization fields are radially coherent in given zones of the media.

19. The method of claim 18 further including demodulating the phases from the timing synchronization signals read from the timing synchronization fields in multiple tracks during a seek operation.

20. A write clock control system comprising
a write clock controller that produces a phase offset based on a phase difference between a write clock signal with constant phase and a signal read from a media pattern that corresponds to a given timing synchronization field, and a frequency offset based on the phase offsets associated with the given timing synchronization field, and previously read timing synchronization fields;
a phase integrator that integrates an integrand that is based on the frequency offset and produces frequency control signal;
an adder that combines the frequency control signal and the phase offset to produce a phase and frequency control signal, and
a phase interpolator that produces an updated write clock signal based on the phase and frequency control signal.

21. The control system of claim 20 wherein the clock controller samples the signal read from the given timing synchronization field under the control of the write clock.
